(19) United States
(12) Patent Application Publication
(10) Pub. No.: US 2019/0387057 A1
(43) Pub. Date: Dec. 19, 2019

(54) INFERRING THE RELATIVE LOCATIONS OF SENSORS IN A SENSOR NETWORK

(71) Applicant: International Business Machines Corporation, Armonk, NY (US)

(72) Inventors: Samuel S. Adams, Rutherfordton, NC (US); Scott Gerard, Wake Forest, NC (US); Aliza R. Heching, Bronx, NY (US); Susann M. Keohane, Austin, TX (US)

(21) Appl. No.: 16/008,721

(22) Filed: Jun. 14, 2018

(51) Int. Cl. H04L 29/08; G06N 5/04; H04L 12/24

(52) U.S. Cl. CPC H04L 67/12; H04L 41/12; G06N 5/04

(57) ABSTRACT

A system is provided for inferring sensor topology in a structure. The system includes a receiver, a server communicatively coupled to the receiver and a sensor topology engine communicatively coupled to the receiver and the server. The receiver is configured to receive identification information that sensors have been and deployed throughout the structure to sense a presence of an operator and to receive sensor readings from the sensors and couple the sensor readings to the sensor topology engine. The sensor topology engine is further configured analyze the identification information and the sensor readings to infer zones of the multiple spaces in which the presence of the operator is sensed by at least one of the sensors, borders of each of the zones, and dead zones adjacent to one or more of the zones in which the presence of the operator is not sensed and build a topological graph.

### BACKGROUND

The present invention generally relates to sensor networks and, more specifically, to a system in which readings from a network of Internet of Things (IoT) sensors are analyzed to infer or learn the relative locations of the IoT sensors in the network, as well as the space in which the IoT sensor network is located, without requiring the IoT sensors to generate any direct spatial or location information.

The IoT is a network of physical devices, vehicles, home appliances and other items. IoT devices are typically embedded with electronics, software, sensors, actuators, and transmission/reception components that enable the IoT devices to connect and exchange data with each other or with a central server. This creates opportunities for more direct integration of the physical world into computer-based systems and can result in efficiency improvements, economic benefits and reduced need for human intervention.

### SUMMARY

Embodiments of the present invention are directed to a system for inferring sensor topology in a structure defining multiple spaces and multiple pathways between the multiple spaces. Non-limiting embodiments of the system include a receiver, a server communicatively coupled to the receiver and a sensor topology engine communicatively coupled to the receiver and the server. The receiver is configured to receive identification information that identifiably registers with the server sensors that have been deployed throughout the structure to sense a presence of an operator and the receiver is further configured to receive sensor readings from the sensors and couple the sensor readings to the sensor topology engine. The sensor topology engine is further configured to analyze the identification information and the sensor readings to infer zones of the multiple spaces in which the presence of the operator is sensed by at least one of the sensors, borders of each of the zones, and dead zones adjacent to one or more of the zones in which the presence of the operator is not sensed and build a topological graph of the structure, the location of the sensors within the structure, the zones with the respective borders, and the dead zones.

Embodiments of the present invention are directed to a method of inferring a sensor topology in a structure having multiple spaces and multiple pathways between the multiple spaces. Non-limiting embodiments of the method include deploying sensors throughout the structure. The non-limiting embodiments of the method further include defining a zone within at least one or more of the spaces or one or more of the pathways in which presence of one or more individuals is sensed by a sensor and defining dead zones between zones within at least one or more of the spaces or one or more of the pathways in which presence of one or more individuals is not sensed by a sensor. The non-limiting embodiments of the method still further include developing a topological graph of the structure, the sensors, the zones and the dead zones, analyzing movements of one more individuals in and through the zones and the dead zones and taking a mitigation action in an event the movements of the one or more individuals is determined to be abnormal from results of the analyzing.

Embodiments of the invention are directed to a method of operating a sensor system. Non-limiting embodiments of the method include tracking a time of presence of one or more individuals in each zone of each sensor of the sensor system and calculating an average time-in-zone (TIZ) for each zone and each dead zone defined where the presence of the one or more individuals is unreported by any sensor of the sensor system. The non-limiting embodiments of the method further include determining from the average TIZ for each zone and each dead zone whether each zone and each dead zone is a destination location or a pass-through location and generating an extended target TIZ for each zone and each dead zone determined to be a destination location and a shortened TIZ for each zone and each dead zone determined to be a pass-through location.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 is a top-down view of a structure in which a sensor system is deployed in accordance with embodiments of the present invention;

FIG. 2 is a schematic illustration of networked components of the sensor system of FIG. 1 in accordance with embodiments of the present invention;

FIG. 3 is a schematic illustration of first and second zones and a dead zone between the first and second zones in accordance with embodiments of the present invention;

FIG. 4 is a top-down view of a topological graph of the structure of FIG. 1 including sensors, zones and dead zones in accordance with embodiments of the invention; and

FIG. 5 is a flow diagram illustrating a method of operating a sensor system in accordance with embodiments.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Turning now to an overview of technologies that are more specifically relevant to aspects of the invention, recent initiatives in home health care markets, such as elder care concerns, aim to use IoT sensors in a patient's home. These IoT sensors would be connected to each other and to central servers where at least one of which is capable of executing cognitive algorithms that allow the overall system to effectively watch over the patient. The goals of the initiatives are often to mitigate problems or to quickly notify caregivers when incidents occur.

Often, a critical element in the build-out of the IoT systems is the outfitting of homes with the IoT sensors. Doing so for multiple IoT sensors will be laborious if the outfitter must meticulously record the location, orientation and range of each sensor, plus the floor plan of each home. This issue can be even more onerous if unskilled home owners or unqualified outfitters instrument the homes. In addition, it is typically the case that furniture and sensors will get moved over time by family and friends who are also unqualified outfitters. If the sensor database is not correctly updated when these moves occur, the results of all further analytics will be compromised. Also, for elder care initiatives in particular to be successful, it is usually necessary to outfit a large number of homes and labor costs of such outfitting across a large number of homes will be very expensive.

Turning now to an overview of the aspects of the invention, one or more embodiments of the invention address the above-described shortcomings of the prior art by avoiding the need for operators (qualified or not) to register metadata for each IoT sensors that is deployed in a home while that home is instrumented. Thus, the following description relates to a system that allows for an automatic population of IoT sensor metadata using the results of statistical analysis, such as the correlation of sensor readings and the relationship between those sensors readings with other contextual information. For example, if a motion sensor is triggered by the motion of a patient every morning and is followed by the activation of a refrigerator door sensor shortly thereafter, we can begin to infer that there is a spatial relationship between the motion sensor and the kitchen (assuming that the refrigerator is positioned in the kitchen and the amount of time taken by the patient to move from the area of the motion sensor to the kitchen is reasonably consistent) once a sufficient amount of data is mined. In a further example, if multiple motion sensors are provided along a path from a first location in a home to the kitchen such that there is a portion of the path characterized as being without a motion sensor, that portion of the path is considered a dead zone and is identified by the system by reference to adjacent zones along the path. The system can subsequently monitor time that is spent in each zone and the dead zone to determine whether a problem exists.

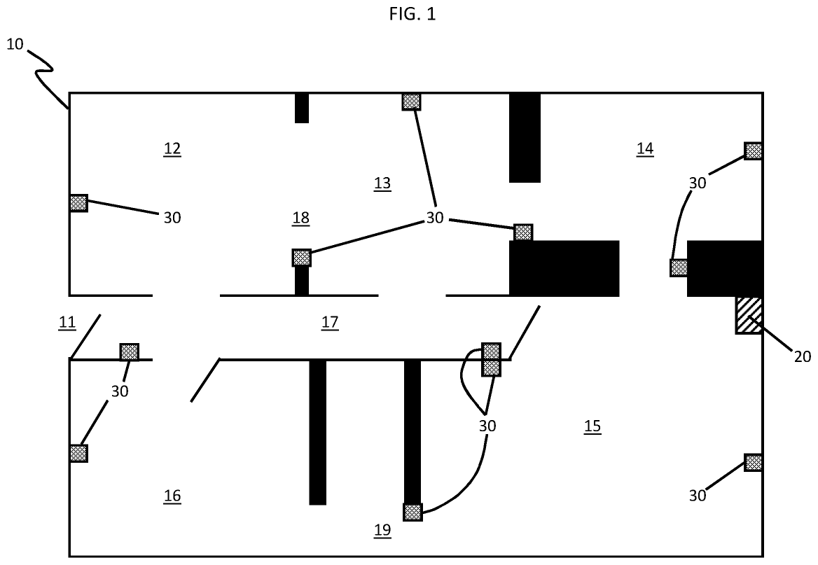

Turning now to a more detailed description of aspects of the present invention, FIG. 1, a system for inferring sensor topology is provided for use in a structure 10. The structure 10 can be any type of business, commercial or residential structure but will be described herein as a residential structure of a patient (e.g., an elder care patient) for purposes of clarity and brevity. The structure 10 is formed to defining multiple spaces, such as an entryway 11, a living room 12, a dining room 13, a kitchen 14, a bedroom 15 and a bathroom 16 as well as multiple pathways, such as main hallway 17 and walkways 18 and 19 between the multiple spaces.

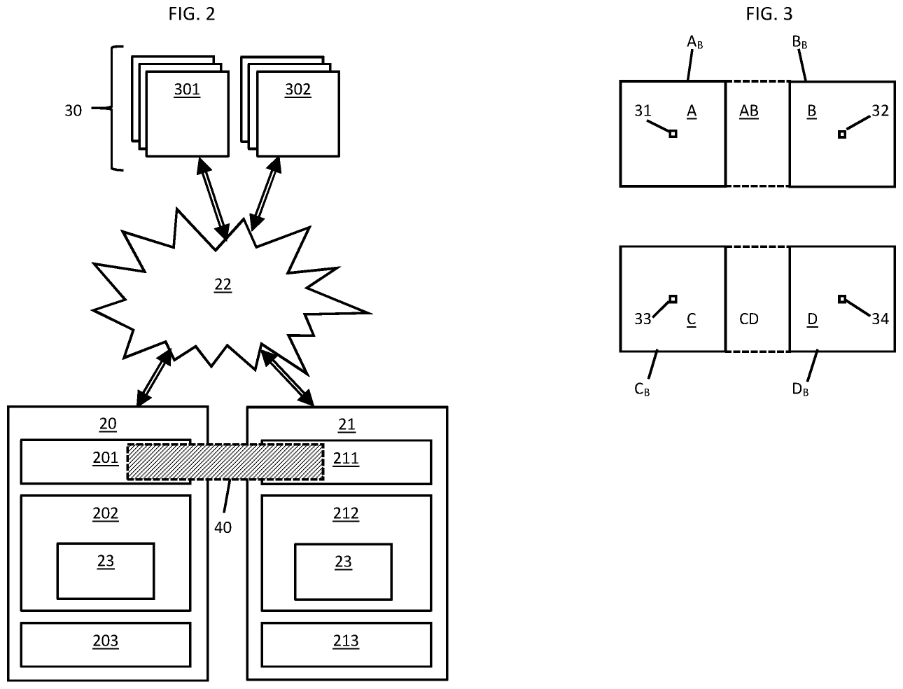

With continued reference to FIG. 1 and with additional reference to FIG. 2, the system includes a server, which can be provided as a local gateway server 20 (see FIGS. 1 and 2) or as a remote or cloud server 21 (see FIG. 2). In some embodiments of the invention, the system includes sensors 30 that are deployed throughout the structure 10. In some embodiments of the invention, the system can include a sensor topology engine 40 (see FIG. 2) that is embodied within at least one or more of the local gateway server 20 and the remote or cloud server 21.

The sensors 30 can be provided as fixed sensors 301 that are affixed to fixed elements of the structure 10 or mobile sensors 302 that are fixed to individuals moving throughout the structure 10. In either case, the fixed sensors 301 and the mobile sensors 302 can be configured to be responsive to a beacon signal and/or to sense at least one of motion, audio signals and optical signals as an indicator of a presence of one or more individuals at a proximal location. Once deployed through the structure 10, the sensors 30 are registered with the local gateway server 20 or the cloud server 21 using some form of identification thereof and are subsequently operative to conduct continued sensing.

For the case of the sensors 30 being responsive to the beacon signal, it is to be understood that the beacon signal can be emitted from an emitter carried by an operator or another individual during at least a test phase of the system. Such a test phase can be carried out in order to initiate the operation of the sensor topology engine 40 as will be described below in greater detail.

As shown in FIG. 2, the local gateway server 20 and the remote or cloud server 21 each include respective processing units 201 and 211, respective memory units 202 and 212 and respective receivers (hereinafter referred to as “networking units”) 203 and 213. The respective memory units 202 and 212 have executable instructions stored thereon, which are readable and executable by the respective processing units 201 and 211. When they are read and executed by the respective processing units 201 and 211, the executable instructions cause the respective processing units 201 and 211 to effectively operate as the sensor topology engine 40.

That is, when they are read and executed by the respective processing units 201 and 211, the executable instructions cause the respective processing units 201 and 211 to register the sensors 30 and to subsequently communicate with the sensors 30 via network 22 whereby readings of the sensors 30 are reported to the respective processing units 201 and 211. The registering can, for example, result in the formation of a sensor map 23 in the respective memory units 202 and 212 whereby each of the sensors 30 can be identified by the sensor topology engine 40 by its identification and by operational details thereof.

In addition, when they are read and executed by the respective processing units 201 and 211, the executable instructions further cause the respective processing units 201 and 211 to infer an existence of zones of the entryway 11, the living room 12, the dining room 13, the kitchen 14, the bedroom 15 and the bathroom 16 as well as the main hallway 17 and the walkways 18 and 19 in which the presence of the one or more individuals is sensed by at least one of the sensors 30, to infer where borders of each of the zones are located so that respective ranges of the sensors 30 and respective distances between the zones can be determined and to infer where dead zones are located. The dead zones are those regions which are adjacent to one or more of the zones and in which the presence of the one or more individuals is not sensed. Also, when they are read and executed by the respective processing units 201 and 211, the executable instructions cause the respective processing units 201 and 211 to build a topological graph of the structure 10, the sensors 30, the zones with the respective borders thereof and the dead zones.

In embodiments of the invention, the sensor topology engine 40 can include a sensor topology classifier configured and arranged to execute a sensor topology machine learning (ML) algorithm to, in effect, extract features from received sensor readings (e.g., readings from sensors 30) in order to “classify” or “learn” relationships that are represented by the sensor readings. In embodiments of the invention, all of the operations of the sensor topology engine 40 described herein can be implemented using the sensor topology classifier and the sensor topology ML algorithm. Referring again to a previously described example, if a motion sensor is triggered by the motion of a patient every morning and is followed by the activation of a refrigerator door sensor shortly thereafter, the sensor topology classifier and sensor topology ML algorithm “learn” that there is a spatial relationship between the motion sensor and the kitchen (assuming that the refrigerator is positioned in the kitchen and the amount of time taken by the patient to move from the area of the motion sensor to the kitchen is reasonably consistent) once a sufficient amount of data is mined. In a further example, if multiple motion sensors are provided along a path from a first location in a home to the kitchen such that there is a portion of the path characterized as being without a motion sensor, the sensor topology classifier and the sensor topology ML algorithm will “learn” that that portion of the path is likely to be a dead zone and is identified by the system by reference to adjacent zones along the path. Examples of suitable classifiers include but are not limited to neural networks, support vector machines (SVMs), logistic regression, decision trees, hidden Markov Models (HMMs), etc. The end result of the classifier's operations, i.e., the “classification,” is to predict a class for the sensor readings. The sensor topology ML algorithms implemented by the sensor topology classifier of the sensor topology engine 40 apply machine learning techniques to the received sensor readings in order to, over time, create/train/update a unique “model” in the form of the spatial relationships of the structure 10 (shown in FIG. 1) including multiple spaces, such as the entryway 11, the living room 12, the dining room 13, the kitchen 14, the bedroom 15 and the bathroom 16 as well as multiple pathways, such as main hallway 17 and walkways 18 and 19 between the multiple spaces. The learning or training performed by the sensor topology engine and the sensor topology ML algorithms can be supervised, unsupervised, or a hybrid that includes aspects of supervised and unsupervised learning. Supervised learning is when training data is already available and classified/labeled. Unsupervised learning is when training data is not classified/labeled so must be developed through iterations of the classifier. Unsupervised learning can utilize alternative learning/training methods including, for example, clustering, anomaly detection, neural networks, deep learning, and the like

With reference to FIG. 3, as a result of an execution of a test phase of a given system, in which fixed sensors 31-34 are registered and an operator with a beacon signal emitter walks through a given space so that the fixed sensors identifiably respond to the beacon signal and report their readings to the sensor topology engine 40, the sensor topology engine 40 determines that first zone A for fixed sensor 31 exists in the given space with border A_{B} defining the range of fixed sensor 31, that second zone B for fixed sensor 32 exists in the given space with border B_{B} defining the range of fixed sensor 32, that third zone C for fixed sensor 33 exists in the given space with border C_{B} defining the range of fixed sensor 33 and that fourth zone D for fixed sensor 34 exists in the given space with border D_{B} defining the range of fixed sensor 34 (notably, while the zones A-D are drawn as rectangles in FIGS. 1, 3 and 4, this is done for clarity and it is to be understood that the actual zone of a given sensor would more likely be circular or elliptical). An additional result is that the sensor topology engine 40 determines that dead zones AB and CD are defined between zones A and B and between zones C and D, respectively, as being regions in the given space in which the individual and the beacon signal are not sensed or responded to by the fixed sensors 31-34.

In accordance with embodiments of the present invention, the fixed sensors 31-34 of FIG. 3 can be configured to sense one individual at a time or multiple individuals at a time. In the former case, the operator conducting the test phase might be required to be alone in the given space for at least as long as the test phase is conducted. In addition, it is to be understood that the fixed sensors 31-34 can be arranged or configured with an overlapping sensing range. In such cases, the sensor topology engine 40 can be configured to initially assume that none of the fixed sensors 31-34 overlap but to allow for the definition of the zones A-D to be modified over time and to be split in some cases (e.g., into zone X, zone Y and zone XY).

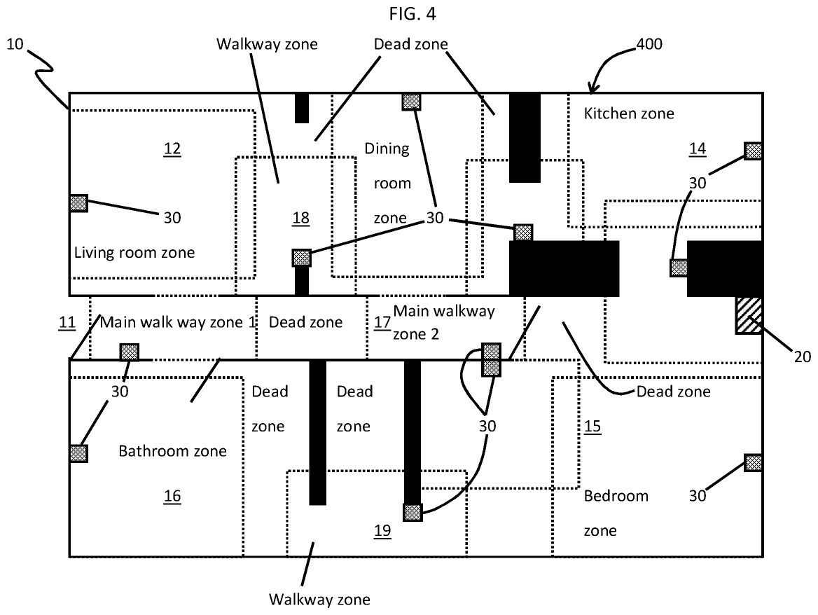

With reference to FIG. 4, when the sensor topology engine 40 is activated for the structure 10 of FIG. 1, the sensor topology engine 40 can define zones with borders and dead zones, as explained with reference to FIG. 3, for the structure 10 and thus generate a topological graph 400 that illustrates the structure 10, the sensors 30, the various zones and borders for each of the sensors 30 and the dead zones in the regions between the zones. In accordance with embodiments of the present invention, the topological graph 400 can be provided or displayed as a two-dimensional rendering 401.

Once the topological graph 400 is generated, continued operation of the sensors 30 and the sensor topology engine 40 allows movements of the operator or one or more other individuals to be tracked through the structure 10. Such tracking can allow the sensor topology engine 40 to develop data, information and knowledge about the structure 10 and the sensors 30 that can be analyzed and thus used in taking mitigation actions for abnormal events.

In an exemplary case, the sensor topology engine 40 can track the movements of one or more individuals within the structure 10 over many days, weeks or months. From the tracking, the sensor topology engine 40 can determine the times the presence of the one or more individuals are sensed in each zone and each dead zone of the structure 10. Averages of these times (along with mean values of these times, upper and lower limits of these times, etc.) can be calculated for each of the one or more individuals as an average time-in-zone (TIZ) for each zone and each dead zone over various lengths and types of time periods.

For the zones and dead zones in locations of the structure 10 where a person would typically linger, such as the zones and dead zones in the living room 12 at a sofa or the kitchen 14 in front of the refrigerator, the respective TIZs would tend to be larger than the respective TIZs of the zones and the dead zones in locations of the structure 10 where a person would not typically linger, such as the zones and the dead zones in the main hallway 17. Thus, the sensor topology engine 40 can determine from at least the average TIZ for each zone and each dead zone whether each zone and each dead zone is a destination location, such as the region in front of the refrigerator in the kitchen 14, or a pass-through location, such as the zones and the dead zones of the main hallway 17. The sensor topology engine 40 can then generate an extended target TIZ for each zone and each dead zone that is determined to be a destination location (e.g., 3 minutes of lingering time for the zone in front of the refrigerator in the kitchen 14) and a shortened TIZ for each zone and each dead zone determined to be a pass-through location (e.g., 5 seconds or less of time for each zone and dead zone in the main hallway 17). Once the extended and shortened target TIZs are generated, the sensor topology engine 40 can determine if an abnormal event is occurring and requires action.

For example, for the topological graph 400 of FIG. 4, if one or more individuals is tracked while moving throughout the structure 10 and continually spends an amount of time within each of the zones and the dead zones that is consistent with the extended and shortened TIZs for each of the destination or pass-through locations for each of the zones and the dead zones, the sensor topology engine 40 will determine that no abnormal event is occurring and thus will take no mitigation actions. However, if one or more individuals is tracked moving along the main hallway 17 and presence is thus detected in the pass-through locations of the zones nearest the living room 12 (i.e., the main walkway zone 1) in a sequence indicating that movement toward the kitchen 14 is occurring but no such presence is immediately detected in the pass-through location of the zone at the entryway of the kitchen 14 (i.e., the main walkway zone 2), the sensor topology engine 40 will determine that there is a presence within the pass-through location of the dead zone on the way to the kitchen 14 (i.e., the dead zone between main walkway zones 1 and 2). If presence in the pass-through location of the zone at the entryway of the kitchen remains undetected well after the shortened TIZ for the pass-through location of the dead zone on the way to the kitchen expires, however, the sensor topology engine 40 can determine that an abnormal event is occurring and that a mitigation action (such as issuing an alarm or calling the police) needs to be taken.

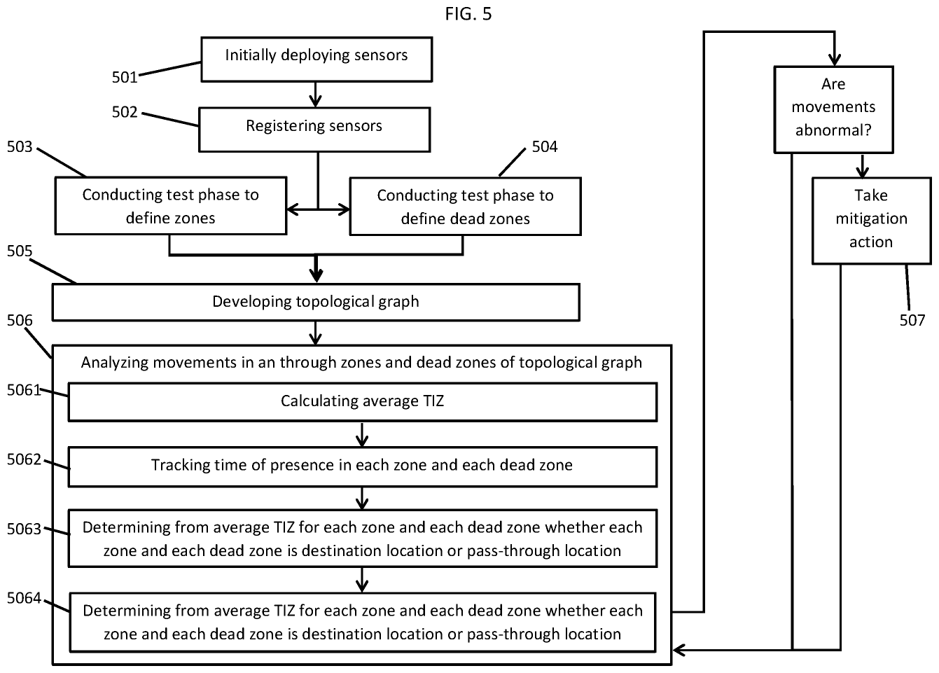

With reference to FIG. 5, a method of inferring a sensor topology in a structure having multiple spaces and multiple pathways between the multiple spaces as described herein is provided. The method includes initially deploying sensors throughout the structure (501) and registering the sensors (502). The method further includes conducting at least a test phase to define zones within at least one or more of the spaces or one or more of the pathways in which presence of one or more individuals is sensed by a sensor (503) and to define dead zones between zones within at least one or more of the spaces or one or more of the pathways in which presence of one or more individuals is not sensed by a sensor (504). At this point, the method includes developing a topological graph of the structure, the sensors, the zones and the dead zones (505) and then analyzing movements of one more individuals in and through the zones and the dead zones of the topological graph (506).

In an event that results of the analyzing of operation 506 indicate that the movements of the one or more individuals throughout the structure is abnormal (i.e., the results of the analyzing of operation 506 indicate that the one or more individuals exist within any of the destination or pass-through locations for each of the zones and each of the dead zones for periods of time exceeding the extended or shortened TIZ for each of the zones and for each of the dead zones, respectively), the method can include the taking a mitigation action, such as an issuing of an alarm or a calling of the police (507), and having control revert back to operation 506 in a repeating or continuous loop. Conversely, in an event the results of the analyzing of operation 506 indicate that the movements of the one or more individuals throughout the structure is not abnormal (i.e., the results of the analyzing of operation 506 indicate that the one or more individuals exist within any of the destination or pass-through locations for each of the zones and each of the dead zones for periods of time not exceeding the extended or shortened TIZ for each of the zones and for each of the dead zones, respectively), the method can revert back to operation 506 in the repeating or continuous loop.

In accordance with embodiments of the present invention, the analyzing of operation 506 can include tracking a time of the presence of the one or more individuals in each zone and each dead zone (5061), calculating an average time-in-zone (TIZ) for each zone and each dead zone (5062), determining from the average TIZ for each zone and each dead zone whether each zone and each dead zone is a destination location or a pass-through location (5063) and generating an extended target TIZ for each zone and each dead zone determined to be a destination location and a shortened TIZ for each zone and each dead zone determined to be a pass-through location (5064).

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user' s computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A system for inferring sensor topology in a structure defining multiple spaces and multiple pathways between the multiple spaces, the system comprising:
a receiver;
a server communicatively coupled to the receiver; and
a sensor topology engine communicatively coupled to the receiver and the server;
wherein the receiver is configured to receive identification information that identifiably registers with the server sensors that have been deployed throughout the structure to sense a presence of an operator;
wherein the receiver is further configured to receive sensor readings from the sensors and couple the sensor readings to the sensor topology engine;
wherein the sensor topology engine is further configured to analyze the identification information and the sensor readings to:
infer zones of the multiple spaces in which the presence of the operator is sensed by at least one of the sensors, borders of each of the zones, and dead zones adjacent to one or more of the zones in which the presence of the operator is not sensed; and
build a topological graph of the structure, the location of the sensors within the structure, the zones with the respective borders, and the dead zones.

2. The system according to claim 1, wherein the server comprises a local gateway server or a cloud server.

3. The system according to claim 1, wherein the sensor topology engine is embodied in the server.

4. The system according to claim 1, wherein:
the sensors comprise fixed sensors; and
the sensor readings comprise sensed presence readings.

5. The system according to claim 4, wherein the sensors are responsive to beacons.

6. The system according to claim 1, wherein the sensor topology engine receives the sensor readings to the sensor topology engine during a test phase in which only a single operator moves along the multiple pathways between the multiple sensors.

7. The system according to claim 1, wherein the borders of each of the zones define distances between the zones.

8. The system according to claim 1, wherein each dead zone is identified by the sensor topology engine by sequential reference to zones adjacent to the dead zone.

9. The system according to claim 1, wherein the topological graph of the structure, the sensors, the zones with the respective borders, and the dead zones comprises a two-dimensional rendering thereof.

10. The system according to claim 1, wherein the sensor topology engine is further configured to:
track a time of the presence of the individual in each zone and calculate an average time-in-zone (TIZ) for each zone and each dead zone;
determine from the average TIZ for each zone and each dead zone whether each zone and each dead zone is a destination location or a pass-through location; and
generate an extended target TIZ for each zone and each dead zone determined to be a destination location and a shortened TIZ for each zone and each dead zone determined to be a pass-through location.

11. The system according to claim 10, wherein the sensor topology engine is further configured to take a mitigation action in an event the presence of the individual is determined to exist within any of the destination or pass-through locations for each of the zones and each of the dead zones for periods of time exceeding the extended or shortened TIZ for each of the zones and for each of the dead zones, respectively.

12. A method of inferring a sensor topology in a structure having multiple spaces and multiple pathways between the multiple spaces, the method comprising:
deploying sensors throughout the structure;
defining zones within at least one or more of the spaces or one or more of the pathways in which presence of one or more individuals is sensed by a sensor;
defining dead zones between zones within at least one or more of the spaces or one or more of the pathways in which presence of one or more individuals is not sensed by a sensor;
developing a topological graph of the structure, the sensors, the zones and the dead zones;
analyzing movements of one more individuals in and through the zones and the dead zones; and
taking a mitigation action in an event the movements of the one or more individuals is determined to be abnormal from results of the analyzing.

13. The method according to claim 12, further comprising registering the sensors with a local gateway server or a cloud server.

14. The method according to claim 12, wherein the defining and the developing are executed during a test phase in which only a single operator moves along the multiple pathways between the multiple sensors.

15. The method according to claim 12, further comprising identifying each dead zone by sequential reference to zones adjacent to the dead zone.

16. The method according to claim 12, wherein the developing comprises rendering the topological graph as a two-dimensional rendering.

17. The method according to claim 12, wherein the analyzing comprises:
tracking a time of the presence of the one or more individuals in each zone;
calculating an average time-in-zone (TIZ) for each zone and each dead zone;
determining from the average TIZ for each zone and each dead zone whether each zone and each dead zone is a destination location or a pass-through location; and
generating an extended target TIZ for each zone and each dead zone determined to be a destination location and a shortened TIZ for each zone and each dead zone determined to be a pass-through location.

18. The method according to claim 17, wherein the movements of the one or more individuals is determined to be abnormal in an event the results of the analyzing indicate that the one or more individuals exist within any of the destination or pass-through locations for each of the zones and each of the dead zones for periods of time exceeding the extended or shortened TIZ for each of the zones and for each of the dead zones, respectively.

19. A method of operating a sensor system, the method comprising:
tracking a time of presence of one or more individuals in each zone of each sensor of the sensor system;
calculating an average time-in-zone (TIZ) for each zone and each dead zone defined where the presence of the one or more individuals is unreported by any sensor of the sensor system;
determining from the average TIZ for each zone and each dead zone whether each zone and each dead zone is a destination location or a pass-through location; and
generating an extended target TIZ for each zone and each dead zone determined to be a destination location and a shortened TIZ for each zone and each dead zone determined to be a pass-through location.

20. The method according to claim 19, further comprising taking a mitigation action in an event the one or more individuals exist within any of the destination or pass-through locations for each of the zones and for each of the dead zones for periods of time exceeding the extended or shortened TIZ for each of the zones and for each of the dead zones, respectively.
